(19) United States
(12) Patent Application Publication
(10) Pub. No.: US 2012/0137317 A1
(43) Pub. Date: May 31, 2012

(54) Media information system and method

(76) Inventors: Kirill Elizarov, Sunny Isles Beach, FL (US); Piter Elizarov, Perm (RU)

(21) Appl. No.: 13/136,682

(22) Filed: Aug. 8, 2011

Related U.S. Application Data
(63) Continuation-in-part of application No. 13/066,171, filed on Apr. 8, 2011.
(60) Provisional application No. 61/458,724, filed on Nov. 30, 2010.

(51) Int. Cl. H04N 21/43; H04N 21/475

(52) U.S. Cl. 725/13

(57) ABSTRACT

A system and method of the inventive concept is adaptable to receive information (graphic and audio) generated and affected by direct viewer participation and to be aired to the viewers. The system and method of the present invention provides a unique approach for mass media communication channels wherein the information content to be presented to the viewers is determined not by the management of the television channel, but by the viewers actively voting for the topics of their interest and participating in the discussion in the open air, all in accordance with FCC regulations.

### RELATED APPLICATIONS

This is a continuation in part application of a non-provisional application Ser. No. 13/066,171 filed on Apr. 8, 2011 that claims priority to a provisional application Ser. No. 61/458,724 filed on Nov. 30, 2010 and incorporated herewith by reference in its entirety.

### FIELD OF INVENTION

This invention pertains generally to the field of mass media information systems and methods.

### BACKGROUND OF THE INVENTION

Television is an integral part of human live. Web based mass media is an integral part of human live. Television and web media are the major source of information about at least news, sports, politics, and entertainment available to public. From the middle of the past century life of the billions people determined by television, which teaches us how we must live and what we have to do. The television has not been learning how to involve TV watchers for dialog so far. We have a choice to change channels, but we can't interact with television. These opportunities we have got in social media. But here your voice is getting lost in the millions of other voices. If you want to be heard by users from neighborhood, you have to be like celebs from TV. This process is becoming circular and tautological.

Typical television and web media present a serial process wherein a television program or web site interface have a series of images and sounds broadcasted to viewers, but the viewers have limited opportunity or no opportunity at all to participate in the television program or in the web site content. The evolution to a more interactive form of television, or television where the viewer is allowed to participate, was slow given the lack of bidirectional communication channels between the viewer and the television program broadcaster or and the web site owner. When bidirectional communication channels were created, they tended to be of insufficient bandwidth for communication of complex viewer interactions with the television program or web site.

Past century brought new version of network communication of Internet that was expanded into interactive web television. However, viewer participation has been limited to choosing television content, responding to advertising messages, and answering viewer questionnaires or polls. This is primarily because most interactive television programming follows a conventional television paradigm wherein the television programming is wrapped in advertisements; and the only responses needed from an audience are to watch linear pre-recorded programs and to buy advertised items or services.

Little has been done to fully involve the audience in a rich participatory experience where the audience has as much control and influence over the content of an interactive program as the originator of the interactive program or interactive content of web site. This is in contrast to the expectations of some viewers, who want a richer and more satisfying participatory experience within the context of an interactive program. In general however, television channels and most influence web sites are controlled by a certain corporations or government. All information provided to the viewers is censored and controlled by the television channel and web sites. In reality, the traffic of news is “unidirectional”, i.e. viewers can see the information (news, music, commercials, etc.) but cannot comment or participate ‘live’ unless the viewer emails his/her comments or calls the television channel directly for any comments, complains, etc. Therefore, the comments, such as interesting stories, comments, either video or audio or both available with respect to a particular news and available to be viewed or listened by other are not available and cannot be shared, discussed, commented, etc.

One of the alternatives to conventional television is Internet television otherwise known as Internet TV, Web TV or Online TV. Internet television is a television service distributed via the Internet. Some Internet television is known as catch-up TV. Internet television allows the users to choose the program or the television show they want to watch from an archive of programs or from a channel directory. The two forms of viewing Internet television are streaming the content directly to a media player or simply downloading the program to the user's computer. With the “TV on Demand” market growing, these on-demand websites or applications are a must have for major television broadcasters. Similar to the conventional television, all information provided to the viewers is censored and controlled by the management of the Internet TV, wherein the traffic of news is “unidirectional”, i.e. viewers can see the information (news, music, commercials, etc.) but cannot comment or participate ‘live’ unless the viewer email his/her comments or calls the television channel directly for any comments, complains, etc. Therefore, the comments, such as interesting stories, comments, either video or audio or both available with respect to a particular news and available to be viewed or listened by other are not available and cannot be shared, discussed, commented, etc.

Another alternative is Web television, also commonly referred to as Web TV. Web TV is an emerging genre of digital entertainment that is distinct from traditional broadcast television. Delivered originally online via broadband and mobile networks, Web television shows, or Web series, are short-form in nature (2-9 minutes per episode), episodic, and produced in seasons. Similar to the conventional television and Interned TV all information provided to the viewers is censored and controlled by the management of the Web television, wherein the traffic of news is “unidirectional”, i.e. viewers can see the information (news, music, commercials, etc.) but cannot comment or participate ‘live’ unless the viewer emails his/her comments or calls the television channel directly for any comments, complains, etc. Therefore, the comments, such as interesting stories, comments, either video or audio or both available with respect to a particular news and available to be viewed or listened by other are not available and cannot be shared, discussed, commented, etc.

The art is replete with various prior art references teaching different methods and systems of television. United States Patent Publication No. 20090282430 to Gupta teaches systems and methods for collecting viewership data of television and radio broadcast programs. The methods include receiving an AV signal of a broadcast program and supplementary content that contains a tag identifying the broadcast program. The supplementary content is combined with the AV signal to form a data-augmented signal which is subsequently modulated with a carrier signal to form a transmit signal for broadcasting to receivers. Each receiver includes a decoder for extracting the supplementary content and recording the tag identity and time the tag is received. The recorded information is subsequently output to an electronic device or sent directly to a viewership data collection entity.

Another reference, namely United States Patent Publication No. 20030196206 to Shusman teaches a method and system for the creation of interactive programming incorporating viewer interactions. An interactive program includes moderator content generated by the moderator and edited participant commentary, such as interactive messages, and is served by a moderator server. Moderators create and manage interactive programs using a Web site. Viewers register to be participants in interactive programs using the Web site as well. The interactive programs can be distributed as electronic documents written in a markup language such as HTML or XML over a communications network such as the Internet. The interactive programs can also be converted to conventional interactive television content for distribution over an interactive television network. The interactive programs can also be distributed over a virtual private network for use as a collaboration tool by an enterprise such as a business concern. The interactive programs require few processing resources so the interactive programs can be embedded within other Web processes such as electronic commerce and television commerce transactions.

Therefore, a need exists in modern mass media industry for a new mass media system and a method for providing mass media communication, wherein the content of the aired broadcast will be determined and provided by the users and will be based on the users generated content whereby each of the users from groups of users will provide comments that include but are not limited to videos, audio recording, sound messages, text messages, images, etc.

### SUMMARY OF THE INVENTION

A mass media system of the present invention provides an inventive approach to modern media: to select from the user generated content and information (UGC), which circulates inside the groups of users, the topics most commented by users; to select the most searchable topics of content presented at the web based search engines; to create the mixed content from selected UGC, and from selected content presented at the web based search engines; to create the broadcast from mixed content and from different types of offline content brought on/by means of different types of media; to air broadcast to the group of users through Television channel, Web channel, Mobile channel, Radio channel; to receive feedback from the group of users via Web devices, Mobile devices and telecommunication devices—thus creating a mass media with broadcast, the content of which is the same for all groups of users and is determined by the groups of users, in accordance with their mood and interests at the moment of airing by the mass media system.

The mass media system includes a first device, hence the first software system is operably communicated with a plurality of web based search engines (such as for example, Yahoo, Google, Buidu, search engine of Facebook, search engine of Twitter, search engine of CNN, and etc.), for continuously tracking in the open Web the topics most commented by the users and for forming selected groups of topics most commented by the users.

Also, the first software system is configured to receive directly from users a various types of web based user generated content (UGC): one type of UGC is delivered with the help of Web devices; another type of UGC is delivered with the help of Mobile devices integrated with the Web, and yet another type of UGC is delivered with the help of another telecommunication devices integrated with the Web.

At the final step the first software system allows the content taken from the web based search engines and the web based different types of UGC brought on Web devices, Mobile devices and other telecommunication devices to converge into a special type of mixed content.

The mass media system includes a second device, i.e. an offline unit. The software system of the offline unit is operably communicated with the first software system. The software system of the offline unit is configured to receive the mixed content from the first software system, and is configured to receive different types of offline content brought on/by means of offline media. The offline unit is a telecommunication device that is operably communicated with the first device and is based in a place, where the different types of offline content brought on/by means of offline types of media (i.e. telephone calls, books, people, anchor of mass media system, photo, DVD, CD, etc) are being accumulated 24/7 in open air of the mass media system. The offline unit converts visible light rays and audible sound into electrical waves.

The software system of the offline unit calculates the amount of the mixed content (received via the first device), and calculates the amount of the offline content, selecting each of the most commented topics of the mixed and offline content to determine the score of each of the most commented topics thereby separating the most commented topics according to the score to select the topic with the highest score. The second software system is configured to receive the most commented topics from the groups of users in response to the broadcast presented to the groups of users with the help of telecommunication channels of the mass media system. The users vote for the topics of the broadcast of their choice, i.e. the topic that each particular user wants to discuss, and provide the UGC, that the user believes to be interesting and worth sharing with the others in the next circle of further broadcast of the mass media system.

The anchorman of the mass media system, who is a part of the offline unit, changes the topics for discussion as the score of one topic being discussed and transmitted is changed by the higher score of another topic. Also the anchor of mass media system moderates, edits the users discussion of the elected topic. Offline users participate in discussion in broadcast of the mass media system through various telecommunication devices, which are to be connected to the offline unit. Online users participate in a discussion in broadcast of the mass media system with the help of mixed content, which is to be delivered to the offline unit by virtue of the first device. Anchorman of mass media system, and online users, and offline users are interact and communicate each other in the broadcast of mass media system. The users from the groups of users present their feedback (their opinions, comments, offering new aspects of the topic and theme and demand to change and take totally new topic for further discussion) to the anchorman of the mass media system, who is a part of the second device, i.e. of the offline unit of the mass media system.

The software system of the offline unit has an extender software, which is configured to converge all types of the received mixed and offline content into broadcast and is configured to increase the time of the topic being discussed from the pre-programmed time of broadcast to the extended time based on popularity and input of the mixed and offline content.

The mass media system includes a controller, which is a telecommunication device that is operably communicated with the offline unit, i.e. the second device, i.e. a software system of the controller is operably communicated with the software system of the offline unit and converts the received broadcast back into electrical waves for transmitting through Television channel, Web channel, Mobile channel, and Radio channel for presenting to the groups of users.

The mass media system of the present invention creates a bidirectional traffic of information, wherein the first direction of the traffic is the broadcast from the mass media system to the groups of users through Television channel, Web channel, Mobile channel, and Radio channel, and the opposite direction of traffic is the UGC delivered from the groups of users to the mass media system via Web devices, Mobile devices and telecommunication devices.

A method of circulating of the UGC i.e. of the transient images of fixed and/or moving objects together with sound, which have information value for a user, represents a continuous cycle of interaction between the mass media system and the groups of users, wherein the content self-replicates when circulating between the mass media system and the groups of users. In the process of circulating, the UGC develops into the selected topics of mixed content, catalyzes, modifies, transforms due to the offline content brought on/by means of offline types of media; converts into broadcast, which is later being aired to the groups of users and replicates itself by virtue of the activity of groups of users.

The method begins with continuously tracking in the open Web the topics most commented by the users, and receiving various types of web based user generated content (with the help of Web devices, Mobile devices and other telecommunication devices integrated with the Web) thereby with the help of first device forming selected topics of the mixed content.

The method continues with receiving the offline user generated content brought on offline types of media; converging the mixed content and offline content with the help of the extender software into the broadcast; converting the broadcast into relative types of broadcast with the help of the controller for airing through Television channel, through Web channel, through Mobile channel, and through Radio channel, etc. for presenting the broadcast to the groups of users. The method further continues with creating a new UGC with the help of groups of users in response to the received broadcast—thus the UGC reproduces itself and updates due to the activity of the groups of users. The method then calculates the number of the users from the groups of users selecting each of the most searchable topics of the UGC to determine the score of each of the most searchable topics. The method further includes the step of separating the most searchable topics of the UGC according to the score to select the topic with the highest score. The method allows to continuously monitor the UGC to select the topic with the highest score to be discussed by the users in the broadcast of the mass media system as the broadcast is being transmitted to the groups of users, and change the topics for discussion as the score of one topic being discussed and transmitted is changed by the higher score of another topic, thereby creating bidirectional traffic of the UGC between the users and the mass media system.

An advantage of the present invention is to provide a system and method that create an entirely new mass media system, wherein the content of the aired broadcast is determined and provided by the users and is based on the users generated content (UGC), and wherein each of the users from groups of users provides comments that include but are not limited to videos, audio recording, sound messages, text messages, images, etc.

Another advantage of the present invention is to provide a system and a method that allows a vast number of the users from the groups of users be on the air of the mass media system at the same time. This advantage allows hosting a vast number (e.g. thousands during one hour of airing by the mass media system) of “live” connections between the users and the system.

Still another advantage of the present invention is to provide a system and a method, wherein the groups of the users account hundreds of millions of participants that function as newsmakers, as nonprofessional correspondents for the network of the mass media system. Any user becomes a supplier of information that he/she sends to the mass media system; he/she does not get any salary or bonuses. The mass media system does not allocate money to support this huge nonprofessional network of the groups of users and does not bear any expenses to maintain the input of UGC.

Still another advantage of the present invention is to provide a system and a method, wherein any advertising message, put on the air of the mass media system, gets flash ‘live’ feedback in the form of UGC from the millions of participants of the group of users, thereby the owner of the advertising can quickly—contrary to the traditional mass media—evaluate the efficiency of their commercials.

Still another advantage of the present invention is to provide an improved system and method to increase subscriptions to the mass media system service provider.

Still another advantage of the present invention is to provide an improved system and method that enhances the viewership of a broadcast.

Still another advantage of the present invention is to provide a system and a method, wherein the new mass media system based on a certain group of users allows a company that is the owner of the accounts of the certain group of users to increase its market capitalization, which is one of the basic measures of a publicly-traded company. The new mass media system based on the certain group of users is a way to determine the rough value of a company that is the owner of the accounts of the groups of users.

Still another advantage of the present invention is to provide a system and a method, wherein millions of users around the world will have the opportunity to express their opinion and points of view on social and political issues, thereby asserting soft influence over the decisions of theirs governments and parliaments. This mass media system can be one more tool for democratization of the society.

Other advantages and meritorious features of this invention will be more fully understood from the following description of the preferred embodiment, the appended claims, and the drawings; a brief description of which follows.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 illustrates an operational view of the inventive system illustrating layout of various components of the system and communication means between the components;

FIG. 2 illustrates a fragmental operational view of FIG. 1, illustrating one of the segments of the operational components wherein a software of the system receive information from group of users and determines a topic for discussion based on number of the users selected that topic and how this selection is exposed to viewers;

FIG. 3 illustrates another fragmental operational view of FIG. 1, illustrating additional segments of the operational components wherein the software of the system receive information from group of users and determines order of the topics separated by number of the users who voted these topics and reflection of these top selected topics exposed to viewed by the users and then as the most popular topic selected by the system based on highest number of users is further presented for discussion and public view;

FIG. 4 illustrates a first embodiment of a screen shot of inventive system as viewed by the users wherein the screen shot includes several sections with one section illustrating an anchorwoman commenting on news to be discussed and another section is divided into a multitude of cells each presenting certain news topics indicating titles of such topics and number of users who voted for each of the topics;

FIG. 5 illustrates an alternative embodiment of the first embodiment of the screen shot of inventive system as viewed by the users;

FIG. 6 illustrates the first embodiment of the screen shot of inventive system as illustrated in FIG. 4 as viewed by the users wherein the screen shot includes several sections with one section illustrating the anchorwoman commenting on news to be discussed, a second section divided into the multitude of cells each presenting certain news topics indicating titles of such topics and number of users who voted for each of the topics, and a third section illustrating enlarged view of the topic with the highest number of viewers who voted for that particular topic;

FIG. 7 illustrates yet another alternative embodiment of wherein the screen shot shows the anchorwoman commenting on two types of the user generated information with one type defined by a video response of one of the users to the topic that was selected by the search engine of the present invention based on the highest number of votes;

FIG. 8 illustrates a screen showing a commercial version of the present invention wherein an anchorman present to the viewers several most popular products as selected by the search engines or provided by manufactures of these products to be advertised and commented on wherein the screen includes several section with one section divided into several slots with each slot presenting these various products and a main area of the screen is left for the anchorman;

FIG. 9 illustrates another view of the screen as shown in FIG. 8 further illustrating one of the products as voted by the users to be the most interested or popular and various forms of the user generated content or information submitted by various users as the users comment of the that particular product by various means including and not limited to text messages, emails, radio, video, and the like and the other part of the screen shot illustrates other products with various forms of the user generated content or information submitted by various users as the users comment of the that particular products by various means including and not limited to text messages, emails, radio, video, and the like; and

FIG. 10 through 12 illustrate various additional embodiments of the screen shots of the present invention.

### DETAILED DESCRIPTION OF THE INVENTION

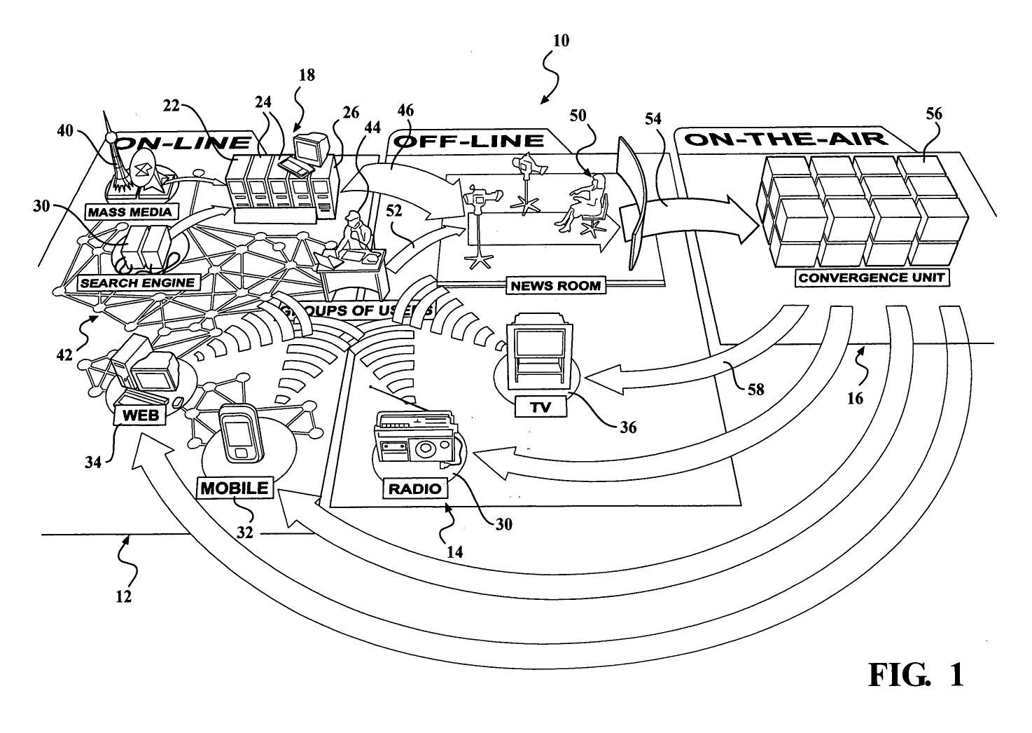

Referring to the Figures, wherein like numerals indicate like or corresponding parts throughout the several views, a concept of the present invention, the mass media system (the system) is generally shown indicated as 10 in FIG. 1. The following terms are used in the present application. Those skilled in the art will appreciate that other related terms with meanings may be used in description of the present invention and the terms used therein are not intended to limit the scope of the present invention. User and viewer means one who uses social network or/and webmail or/and mobile device or/and television device or/and Web device or/and radio device or/and telephone services or/and any open Web services (all services together or at least one of them). Group of users or group of viewer (also users' group or users group or user group) is a group that uses a particular service. A group of users can account from several people to hundreds of millions of participants. Mass media is means of public communication reaching a large group of users. Broadcast (Air) is communication that is transmitted by mass media for the public or for general use. Telecommunication channel—the electronic system used in transmitting of broadcast. Telecommunication device—the electronic apparatus (at the first point of the telecommunication channel and at the end point of the telecommunication channel) used in sending or/and in receiving of broadcast. Telecommunication device converts broadcast content i.e. sound, images of fixed or/and moving objects into electrical waves for transmitting via telecommunication channel and reconverts electrical waves after transmitting via telecommunication channel into broadcast content. Television device (TV device) is a telecommunication device used in television technology, i.e. various types of TV receivers, etc. Mobile device is a telecommunication device used in mobile/cellular phone technology, i.e. various types of mobile phones, smart phones, etc. Web device is a telecommunication device used in Internet technology, i.e. various types of computers, laptops, tablets, etc. Radio device is a telecommunication device used in radio technology, i.e. various types of radio receivers, etc. Content is a combination of one or more elements of sound, images of fixed or/and moving objects, which has information value for a user. User generated content or user generated information (the UGC) is content created by nonprofessional user for noncommercial purpose. Television channel—is a system of telecommunication channels and television devices. Mobile channel—is a system of telecommunication channels and mobile devices or/and Web devices. Web channel—is a system of communication channels and web devices or/and Mobile devices. Radio channel—is a system of communication channels and radio devices. Anchorman is a person that moderates the broadcast of the mass media system.

FIG. 1 illustrates an operational view of the inventive system 10 illustrating layout of various components of the system 10 and communication means between the components. The system 10 presents several functional zones or areas correspondent with activities of the system 10. These functional zones include an online zone, generally indicated at 12, an off-line zone, generally indicated at 14, and an on the air zone, generally indicated at 16.

The system 10 includes a first device or a search engine, generally indicated at 18, of the system 10 operably communicated with a plurality of web bases search engines 20 for continuously scanning the web based search engines thereby tracking most searchable and commented on topics received from individual users, Internet providers such as Yahoo, Google, etc., social network providers such as Facebook, Twitter, Buidu, etc., cable and satellite news channels such as CNN, Fox News, and the like, to identify to identify most searchable topics and presenting the most searchable topics to be exposed to the viewers through a platform, generally indicated at 22.

The first device 18 further includes a second device 22 operably communicated with one another and configured to receive information from the viewers in response to the most searchable topics as presented through the platform 22 thereby calculating number of the users selecting each of the most searchable topics to determine score of each of the most searchable topics to separate the most searchable topics in a consecutive order based on number of the users selecting the most searchable topics.

The first device 18 further includes a user interface device 24 adaptable to receive the user generated content and information including transient images of fixed and moving objects together with sound as the users react to the most searchable topics presented in the consecutive order. The first device 18 includes a controller 26 operatively communicated with the first device 18 and the second device 22 and the user interface device 26 for continuously receiving information as the second device 22 calculates the number of the viewers selecting each of the most searchable topics thereby continuously transforming to the platform 22 the most searchable topic and coordinating the user generated content transmitted from the platform 22 back to the viewers through radio channels 30, mobile channels 32, web bases or Internet channels 34, and conventional television or TV channels 36 thereby creating bidirectional traffic of the user generated content.

These plurality of web bases search engines 20 include and are not limited to the following search such as Yahoo, Google, etc., as indicated at 34, social networks search engines such as Facebook, Twitter, Buidu, etc., and search engines of conventional mass media 40 such as CNN, Bloomberg, Fox, etc. for continuously tracking in the open Web, generally indicated at 42 topics most commented by the users 44 and for continuously receiving different types of the web based UGC brought on Web, Mobile and other telecommunication devices integrated with the web, and generated by groups of users 44 for forming mixed content of topics most commented by the users 44. This mixed content of the most searched topics 46 is then presented to the groups of users 44 through the platform, generally indicated at 50, for delivering transient images of fixed and moving objects together with sound to the group of users and viewers 44. The users 44 provide comments to the most searchable topics, as shown at 52 in FIG. 1. The comments that contain transient images of fixed and moving objects together with sound are then transformed, as shown at 54, to a convergence unit 56. The convergence unit 56 then transfers the comments that contain transient images of fixed and moving objects together with sound to the group of users and viewers 44, as shown at 58.

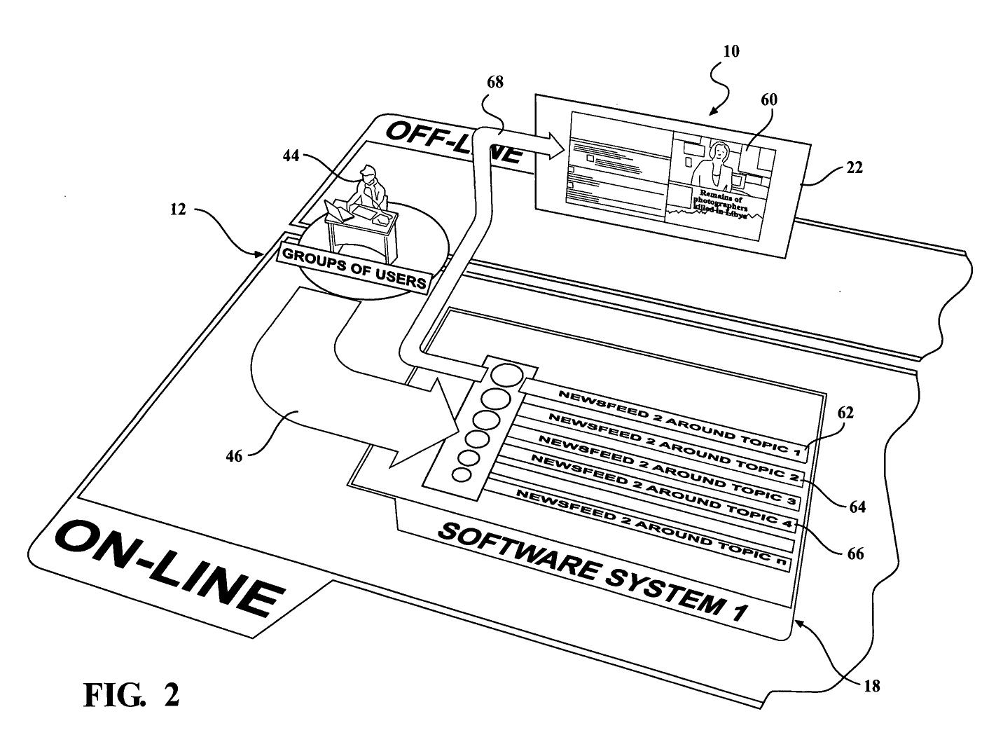

FIG. 2 illustrates a fragmental operational view of FIG. 1, illustrating one of the segments or zones 12 of the operational components wherein the software of the first device 18 receive information from the group of users 44 and determines a topic for discussion based on number of the users 44 selected that topic and how this selection is exposed to viewers through a screen 60 of the platform 22. In particular, as illustrated in FIG. 2, there different topics, as indicated at 46 in FIG. 2, will be processed by the first device 18. The first device will determine and calculate through its software system what newsfeed around its respective topic is the most popular by the users 44.

Again, the most commented topics may be received from the individual users, Internet providers such as Yahoo, Google, etc., the social network providers such as Facebook, Twitter, Buidu, etc., the cable and satellite news channels such as CNN, Fox News, and the like. As shown in FIG. 2, the software identified several topics to be selected for discussion, wherein newsfeed 1 around topic 1, as shown at 62, is the most popular topic for discussion whereby newsfeed 2 around topic 2, as shown at 64, and newsfeed 3 around topic 3, as shown at 66, are less popular as compared to the newsfeed 1 around the topic 1. Thus, the newsfeed 1 around the topic 1 will be transformed by the software to be presented at the screen 60 as shown at 68.

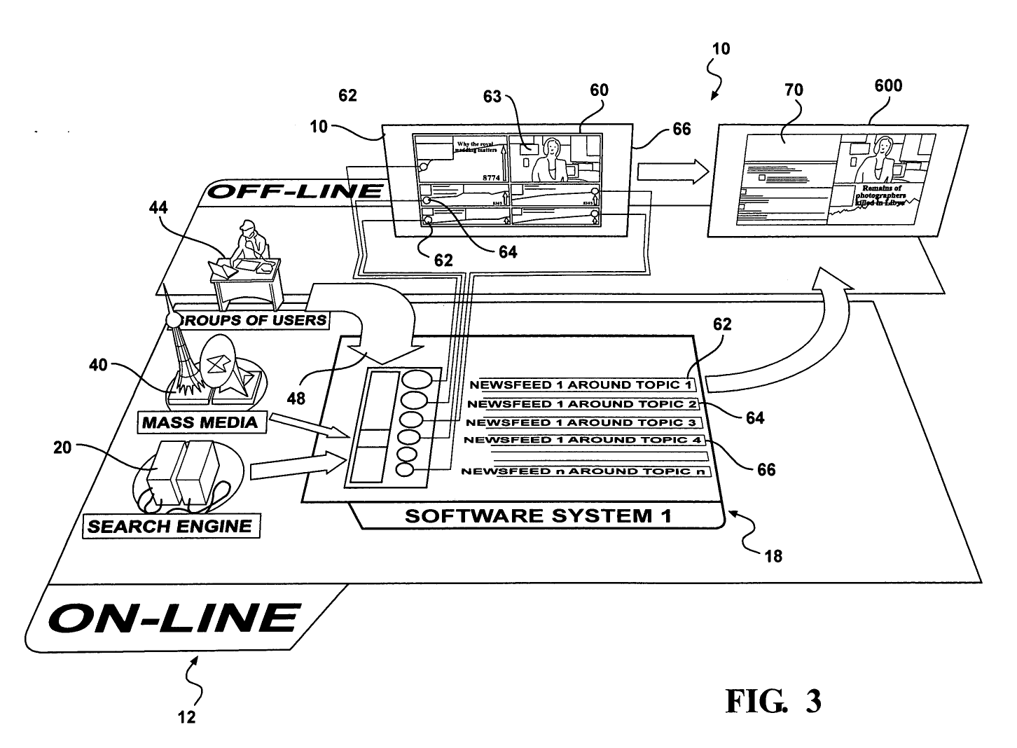

FIG. 3 illustrates another fragmental and more detailed view of FIG. 2, illustrating additional the screen 60 separated into several segments or cells. The screen 60 illustrates location of the newsfeed 1 around topic 1, as shown at 62, in a top left segment of the screen 60 and adjacent another segment 63 located on the right side of the screen and presenting the anchorman commenting on the topics. The other bottom part of the screen 60 in divided into several other segments to position other newsfeeds such as the newsfeed 2 around topic 2, as shown at 64, the newsfeed 3 around topic 3, as shown at 66, and any other additional newsfeeds. As further illustrated at 600, the screen then will show UGC, such as any form of information transmitted through radio, emails, text messages, video concerning the newsfeed 1 around topic 1, as shown at 62.

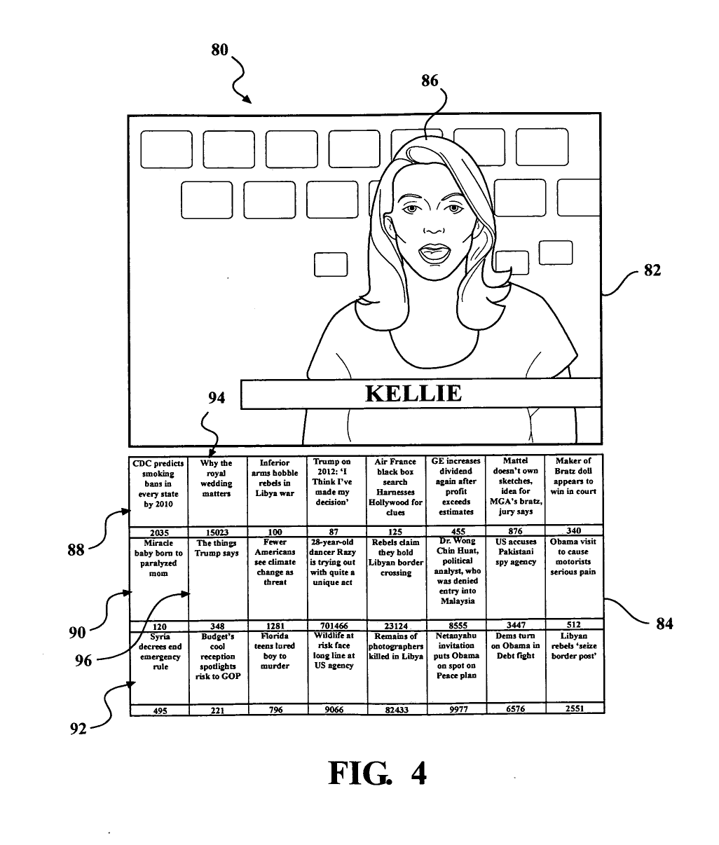

FIG. 4 illustrates a first embodiment of a screen shot of inventive system 10 as viewed by the users. This screen shot is generally shown at 80 and includes several sections or cells 82 and 84 with one section 82 illustrating an anchorwoman 86 commenting on news to be discussed and the other section 84 is divided into a multitude of cells (only several are generally indicated at 88, 90, and 92) each presenting certain news topics indicating titles of such topics, generally indicated at 94, and number of the users who voted for that particular topic, as generally indicated at 96.

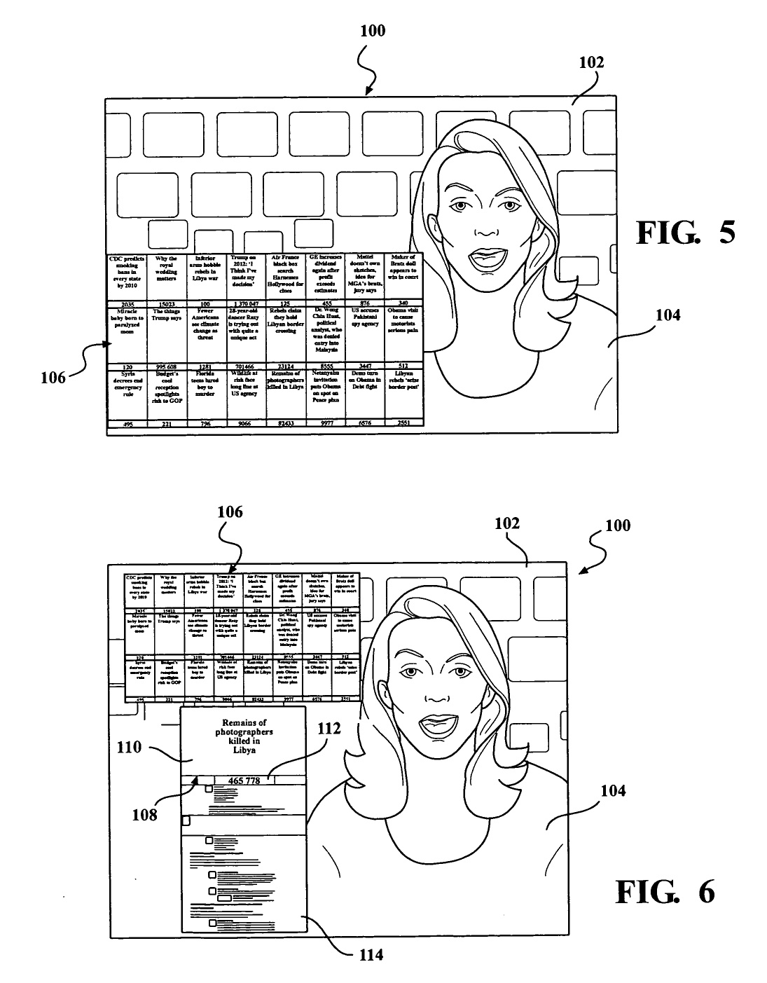

FIG. 5 illustrates an alternative embodiment, generally shown at 100, of the first embodiment of the screen shot of inventive system as viewed by the users 44. This screen shot 100 includes several sections or cells 102 depicting the anchorwoman 104, and another section, generally indicated at 106, divided into a multitude of cells with each cell presenting certain news topics indicating titles of such topics and number of the users who voted for that particular topic.

FIG. 6 illustrates the screen shot 100 of inventive system as illustrated in FIG. 5 as viewed by the users 44. The screen shot 100 includes a third section, generally indicated at 108, illustrating enlarged view of the topic 110 with the highest number of viewers 112 who voted for that particular topic 110. As further illustrated at 114, the screen illustrates UGC, such as any form of information transmitted through radio, emails, text messages, video concerning the topic 110.

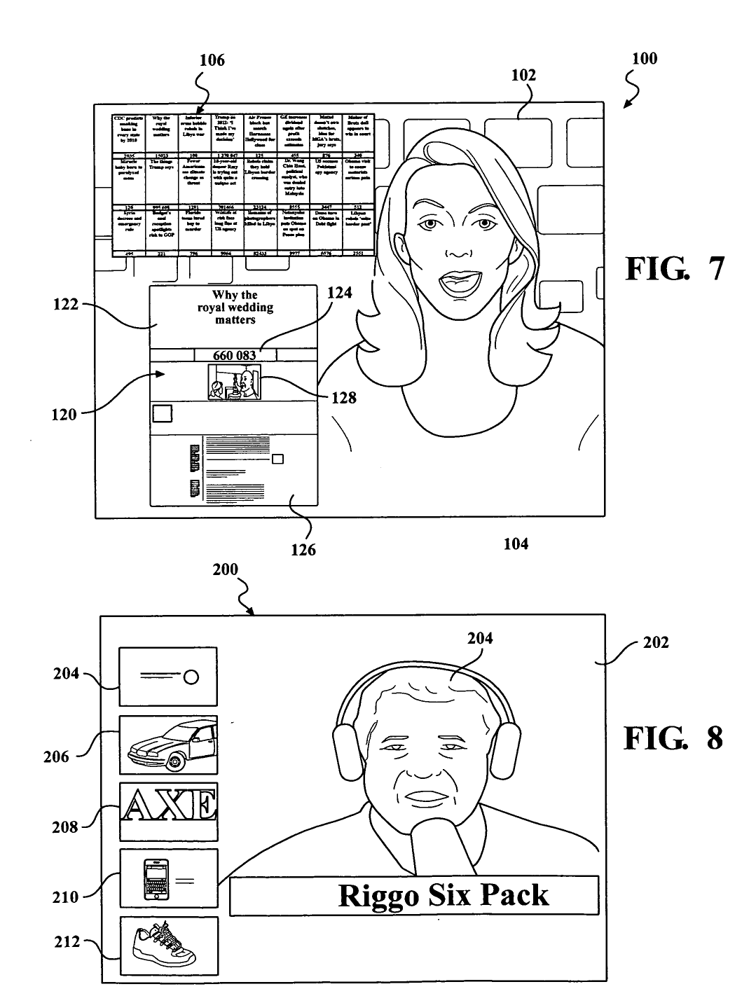

FIG. 7 illustrates yet another alternative embodiment of wherein the screen shot 100 shows the anchorwoman 104 commenting on yet another topic that is shown on a separate cell or segment 120. Here, the topic shown in the segment 122 replaced previous topic based on number of the users 44 at that particular moment who selected the topic 122 as the most popular one according to the score, as shown at 124. Here, there are two types of the UGC with one type defined by a video response (as shown at 128) of one of the users 44 to the topic 122 that was selected by the search engine of the present invention based on the highest number of votes and another type of UGC presented in form of emails, text messages, and the like, as shown at 126.

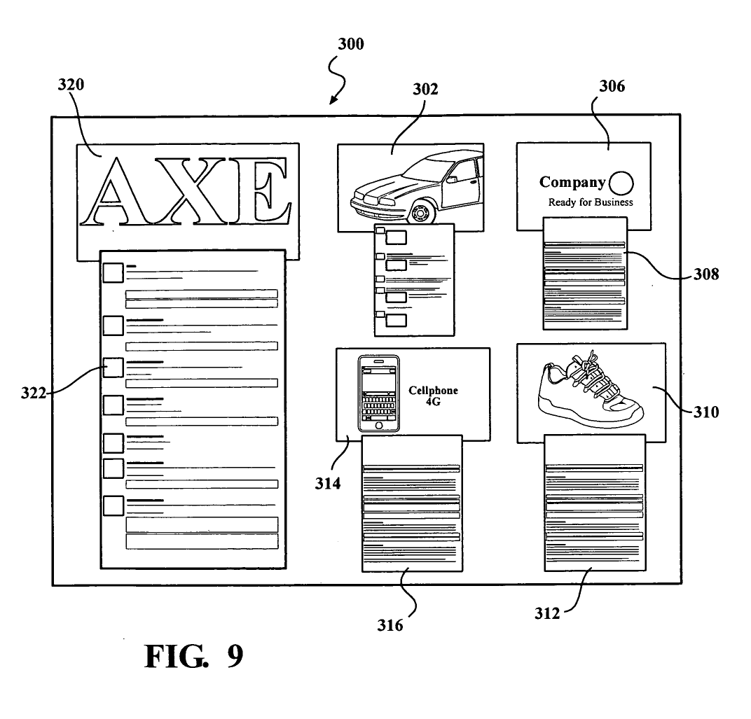

Referring now to FIGS. 8 and 9, a screen shoot, generally shown at 200 in FIG. 8, illustrates a commercial version of the present invention. The screen shoot includes a first section 202 wherein an anchorman 204 present to the viewers several most popular products as selected by the search engines or provided by manufactures of these products to be advertised and commented on. The first section 202 further includes several other sections or cells 204, 206, 208, 210, and 212. Each of the sections or cells 204, 206, 208, 210, and 212 presents these various products to be discussed and commented on.

FIG. 9 illustrates another view, as shown at 300, of the screen as shown in FIG. 8. FIG. 9 further illustrating one of the products as voted by the users to be the most interested or popular, as shown at 320, and various forms of the user generated content or information submitted by various users as the users comment of the that particular product by various means including and not limited to text messages, emails, radio, video, and the like, as shown at 322. The other part of the screen shot 300 illustrates other products or services, as shown at 302, 306, 314, and 310 with various forms of the user generated content or information, as shown at 304, 308, 312, and 316 submitted by various users as the users comment of the that particular products by various means including and not limited to text messages, emails, radio, video, and the like. The popularity of the products or services may change. For example, the product as now shown at 320, may become less commented on and less popular as compared, for example, to product shown at 302. Here, the product 302, will replace spots on the screen 300 with the products shown at 320. Alternatively, a new product (not shown) may appear on the screen 300 based on the results of votes.

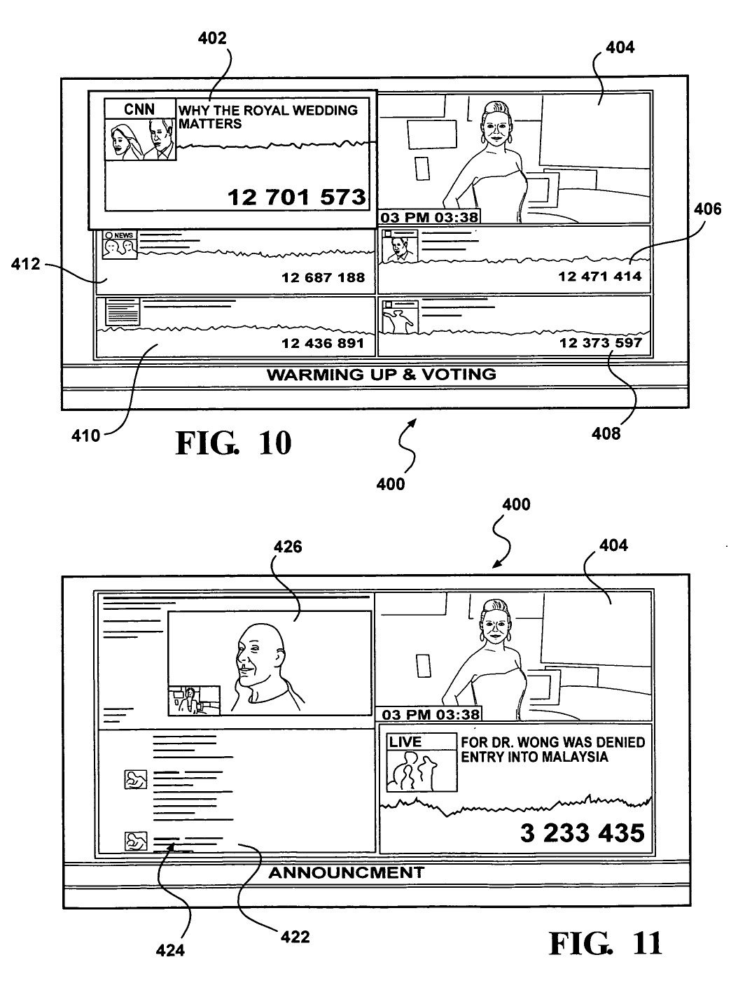

FIGS. 10 through 12 illustrate various additional embodiments of the screen shots of the present invention. FIG. 10 shows a screen, generally shown at 400 including the following segments as presented to the users 44. A first part or segment 404 presents to the users 44 an anchorman or anchorwoman commenting on news. A second segment 402 presents the news that was commented on by highest number of the users 44. For example, as shown in FIG. 10, the most commented news reached 12 701 573 number of the users 44 who considered that particular topic to be the most interesting one. The other four segments 406, 408, 410, and 412 illustrated other fourtopics that were also considered to be the most popular but did not receive the highest number of voters as, for example, the topic shown in the segment 402. The segments 402, 406, 408, 410, and 412 may include various graphical presentation to reflect number of the viewers and users 44 that vote for the particular topic.

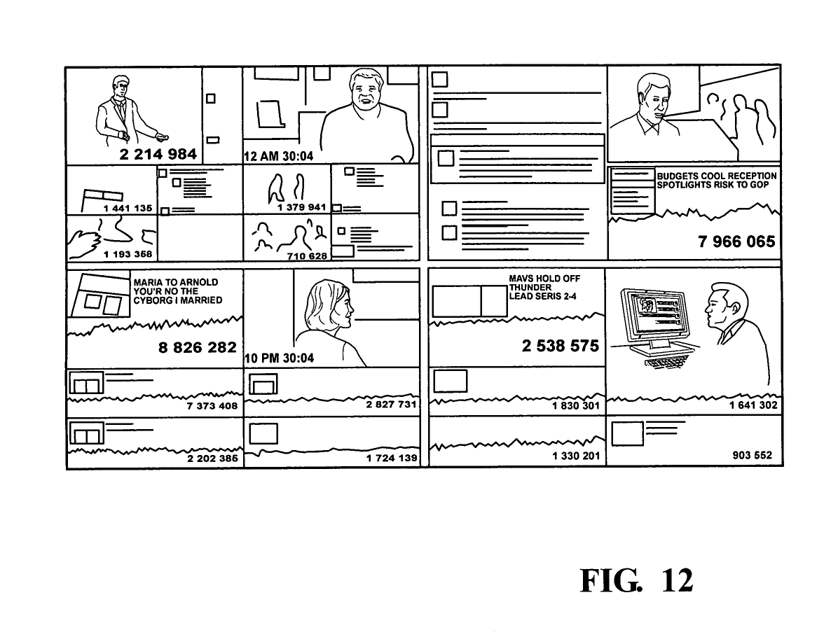

FIG. 11 a next view of the screen 400, wherein the news that was selected by most of the users 44 is shown in the segment 420 that appears below the segment 404. The right part 422 of the screen 400 is divided into at least two parts wherein a life report 426 of the witness of the event discussed in the news as shown at 420 is presented to the users 44 and viewers. All users 44 are commenting on the event by submitting the UGC, as generally indicated at 424 and is presented to other viewers and the users 44. Number, size and configuration of the segments as set forth above is shown for exemplary purposes and is not intended to limit the scope of the present invention. FIG. 12 illustrates yet another additional embodiment of the screen shot of the present invention.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A media circulation system for sending and receiving user generated content, including transient images of fixed and moving objects together with accompanying audio media and for transmitting the user generated content to viewers/participants through devices that convert said information into a format of conventional media technologically generated images accompanying audio media, said media circulation system comprising:
a platform for delivering transient images of fixed and moving objects together with accompanying audio media to the viewers/participants;
a first device operably communicable with a plurality of web based search engines for the purpose of continuously scanning the web based search engines thereby tracking the most searched for and commented on topics received from and presented by individual users, Internet providers, cable and satellite news channels to identify said topics to be exposed to the viewers/participants through said platform;
a second device operably communicable with said first device and configured to receive information from the viewers/participants in response to the most searched for and commented on topics as presented through said platform thereby calculating the number of the users selecting each of said topics, to determine the score of each said topics; to separate said topics in a consecutive order based on and in companion with the number of the users selecting said topics;
a user interface device adaptable to receive the user generated content including transient images of fixed and moving objects together with accompanying audio media in coordination with user reactions to the said topics presented in said consecutive order; and
a media content controller operatively communicable with said first device and said second device and said user interface device for continuously receiving information as said second device calculates the number of the viewers/participants selecting each of the most searched for and commented on topics thereby continuously transferring to said platform said topics and coordinating said user generated content with other participatory devices of said platform transmitting from said platform back to the viewers/participants thereby creating bidirectional traffic of the user generated content.

2. A media circulation system as set forth in claim 1, including a convergence unit cooperable with said platform for receiving the user generated content and separating the user generated content in order to channel the user generated content to radio stations, mobile applications and web based applications to be viewed and listened by the viewers.

3. A media circulation system as set forth in claim 2, wherein said convergence unit is adaptable to transform the user generated content back into electrical waves to be transmitted through a television channel, a web channel, a mobile channel, and a radio channel.

4. A media circulation system as set forth in claim 3, wherein said first device is further defined by the first software adaptable to receive information from the web based search engines, for continuously scanning the web based search engines, thereby tracking the most searched for and the most commented on topics and transmitting information about said topics to said platform, so that the information about said topics can be exposed to the viewers/participants through said platform.

5. A media circulation system as set forth in claim 1, wherein said second device is further defined by the second software for receiving the user generated content and for converging the mixed content and offline content into existing broadcast.

6. A media circulation system as set forth in claim 1, wherein said platform for delivering transient images of fixed and moving objects together with accompanying audio media to the viewers/participants is further defined by a television studio and ancillary television broadcast.

7. A media circulation system as set forth in claim 1, wherein said television studio is further defined by an installation in which television and video productions take place and is processed.

8. A media circulation system as set forth in claim 1, wherein said platform for delivering transient images of fixed and moving objects together with accompanying audio media to the viewers/participants is further defined by a screen presented to the viewers/participants with said screen to include transient images of fixed and moving objects together with accompanying audio media.

9. A media circulation system as set forth in claim 1, wherein said screen is separated into several cells with one of said cells presenting an anchormen informing the viewers/participants about the most searched for and commented on topics as said topics appear on said screen in said consecutive order based on the most searched for and commented on topics by viewers/participants; a user interaction cell for presenting the user generated information in response to said user generated information in response to said topics selected by said second device, and a plurality of cells for presenting graphical information about said topics.

10. A method for circulating a body of user generated information including transient images of fixed and moving objects together with accompanying audio media and to transmit the user generated information to viewers/participants, said method comprising the steps of:
connecting a platform to deliver transient images of fixed and moving objects together with accompanying audio media to the viewers/participants from the first device operably communicable with a plurality of web based search engines, to continuously scan the web based search engines thereby tracking the most searched for and commented on topics received from individual users, Internet providers, cable and satellite news channels, to identify said topics and presenting said topics to the viewers/participants through the platform;
connecting the platform and the first device to a second device to receive information from the viewers/participants in response to the most searched for and commented on topics as presented through the platform to calculate the number of users selecting each of said topics, to determine the popularity score of each said topics, respectively;
separating said topics in a consecutive order based on the number of users selecting said topics; and
connecting a media content controller to the platform, the first device, the second device to continuously receive information as the second device calculates the number of the viewers selecting each of the most searched for and commented on topics thereby continuously transferring to the platform said topics and organizing and sending the user generated information transmitted from the platform back to the viewers/participants to create bidirectional traffic of the user generated information.

11. A method as set forth in claim 10, including the step of connecting a user interface device adaptable to receive the user generated information including transient images of fixed and moving objects together with accompanying audio media as the users react to said topics presented in the given consecutive order.

12. A method as set forth in claim 10, including the step of connecting a convergence unit to the platform to receive the user generated information and to separate the user generated information in order to channel the user generated information to radio stations, mobile applications and web based applications to be viewed and listened to by the viewers as said information is transmitted through a television channel, a web channel, a mobile channel, and a radio channel.

13. A method as set forth in claim 10, including the steps for the utilization of television studio resources.

14. A method as set forth in claim 10, wherein said television studio is further defined as an installation in which television and video productions take place and are processed.

15. A method as set forth in claim 10, wherein the step of installing the television studio is further defined by presenting a screen separated into several cells with one of the cells presenting an anchormen informing the viewers/participants about the most searched for and commented on topics as said topics appear on the said screen in the consecutive order based on the number of the viewers/participants selecting said topics; a user interaction cell for presenting the user generated information in response to said user generated information in response to said topic selected by the said second device, and a plurality cells for presenting graphical information about said topics.
